(19) United States
(12) Patent Application Publication
(10) Pub. No.: US 2004/0163056 A1
(43) Pub. Date: Aug. 19, 2004

(54) System and method for evaluating signal coupling between vias in a package design

(76) Inventors: Mark D. Frank, Longmont, CO (US); Jerimy Nelson, Fort Collins, CO (US); Peter Shaw Modauer, Wellington, CO (US)

Correspondence Address: HEWLETT-PACKARD COMPANY, Intellectual Property Administration, P.O. Box 272400, Fort Collins, CO, 80527-2400, US

(21) Appl. No.: 10/368,776

(22) Filed: Feb. 19, 2003

(51) Int. Cl. G06F 17/50; G06F 9/45

(52) U.S. Cl. 716/5; 716/4; 716/12

(57) ABSTRACT

A method is provided for evaluating via signal coupling in an electronic design (e.g., a package design). In the method, one or more via signal coupling rules are formulated. One or more via pairs designed to carry differential signals are then processed to determine whether the inter-via spacing between the via pairs violates the via signal coupling rules. An indicator (e.g., a DRC and/or a report) is generated to identify violated via signal coupling rules. Processing of the electronic design may be scoped according one or a group of signal nets, or one or a group of levels of the package design.

### RELATED APPLICATION

This application is related to the following commonly owned and co-filed U.S. patent applications, each of which is incorporated herein by reference: SYSTEM AND METHOD FOR EVALUATING VIAS PER PAD IN A PACKAGE DESIGN (Attorney Docket No. 200205297); SYSTEM AND METHOD FOR EVALUATING SIGNAL COUPLING BETWEEN DIFFERENTIAL TRACES IN A PACKAGE DESIGN (Attorney Docket No. 200205298); SYSTEM AND METHOD FOR EVALUATING POWER AND GROUND VIAS IN A PACKAGE DESIGN (Attorney Docket No. 200205299); SYSTEM AND METHOD FOR EVALUATING SIGNAL DEVIATIONS IN A PACKAGE DESIGN (Attorney Docket No. 200205303); and SYSTEM AND METHOD FOR EVALUATING SIGNAL TRACE DISCONTINUITIES IN A PACKAGE DESIGN (Attorney Docket No. 200205304).

### BACKGROUND

Prior art computer aided design (CAD) software is known to include complimentary tool suites for designing and analyzing the package of a die, e.g., a microprocessor. A “package” is the physical interconnection between the die and, for example, a printed circuit board (PCB). A typical package has several interconnected layers between its top level (Level 1), which connects to the die, and its bottom level (Level 2), which connects to the PCB.

A package “design” is a hierarchical and symbolic digital model of the package circuit. Those skilled in the art appreciate that hardware description languages (HDLs) may be used to formulate this digital model. The digital model consists of linked design elements that simulate the package circuit. The design elements are for example digital representations of the transistors, resistors, logic gates, traces (i.e., intra-level conductors), capacitors, vias (i.e., inter-level connectors), and wire bonds that make up the simulated schematic circuit.

The design elements and interconnections are collated and defined in a design database, which is a textual representation of the package design. The design database may further describe the package design in terms of higher-level cells consisting of two or more design elements, and the connections between cells. Each “net” in the package design describes the linked conductors (e.g., traces of a level and vias between levels) that form a circuit between an input and an output of the package. The CAD software may automatically route traces within a given level of the package design; it may further automatically route vias between levels of the package design.

The design database is processed by the CAD software to perform circuit simulation. The CAD software is for example used to model a signal through the package and over a net (i.e., a “signal net”). Substrate laminate technologies and bond interconnections may also be evaluated through the CAD software.

One exemplary prior art CAD software is Advanced Package Designer (APD) from Cadence Design Systems, Inc., of San Jose, Calif. Such CAD software is known to include verification procedures and dynamic feedback that evaluate design accuracy against a set of physical and electrical design rules, or constraints. Physical design constraints help to ensure manufacturability; electrical design constraints help to ensure electrical specifications of the design. By way of example, this CAD software generates a Design Rule Check (DRC) indicating whether the design meets the various constraints. The prior art CAD software also provides a graphical user interface to view all or part of the package design in two dimensions, for example in a flat or perspective rendition, or with levels overlaid relative to one another.

FIG. 1 illustrates one prior art system 10 for designing a package with prior art CAD software 12. CAD software 12 is stored within a computer 14, initially within a storage unit 16. A processor 18 of computer 14 operates CAD software in response to user inputs at an input interface 20 (e.g., a computer keyboard and mouse). As those skilled in the art appreciate, when initialized, CAD software 12 may also load into internal memory 22 of computer 14. A human designer at input interface 20 then controls CAD software 12, through processor 18, to create a package design 24, also stored within memory 22. The designer can command processor 18 and CAD software 12 to graphically show package design 24 at a graphical user interface 26 (e.g., a computer monitor) of system 10. Illustratively, package design 24 is graphically depicted on a display 28 of graphical user interface 26 as a five-level package model 24 shown in FIG. 2.

FIG. 2 illustrates detail of graphical model 24A. L1 of model 24A couples with a die, and L2 of model 24A couples with a PCB. Levels I(1), I(2) and I(3) of model 24A represent intermediate levels of package design 24. Levels L1, I(1), I(2), I(3), L2 are shown as distinct elements and with not-to-scale orientations for ease of illustration. An illustrative signal net 30A is shown from an input connector 32A to an output connector 34A of model 24A. Signal net 30A traverses design elements in the form of traces and vias between connectors 32A, 34A: via 35A from connector 32A of L1 to trace 36A of I(1); trace 36A within I(1) from via 35A to via 38A; via 38A from trace 36A of I(1) to trace 40A of I(2); trace 40A within I(2) from via 38A to via 42A; via 42A from trace 40A of I(2) to trace 44A of I(3); trace 44A within I(3) from via 42A to via 46A, which terminates at connector 34A of L2.

Another signal net 30 is shown from an input connector 32B to an output connector 34B of model 24A. Signal net 30B traverses design elements in the form of traces and vias between connectors 32B, 34B: via 35B from connector 32B of L1 to trace 36B of I(1); trace 36B within I(1) from via 35B to via 38B; via 38B from trace 36B of I(1) to trace 40B of I(2); trace 40B within I(2) from via 38B to via 42B; via 42B from trace 40B of I(2) to trace 44B of I(3); trace 44B within I(3) from via 42B to via 46B, which terminates at connector 34B of L2.

With further regard to FIG. 1, CAD software 12 is also operable to generate a design database 50. In one example, design database 50 textually defines signal nets 30A and 30B of FIG. 2: signal net 30A is defined by connectors 32A, 34A, traces 36A, 40A, 44A, and vias 35A, 38A, 42A, 46A; signal net 30B is defined by connectors 32B, 34B, traces 36B, 40B, 44B, and vias 35B, 38B, 42B, 46B. Design database 50 also includes parameters (often called a “netlist”) to ensure that signal nets 30A and 30B have start and end points (i.e., connectors 32A, 34A for signal net 30A, and connectors 32B, 34B for signal net 30B). A designer can manipulate design database 50 to develop the desired package design 24.

CAD software 12 utilizes design rules 52 to generate one or more DRCs 54 in the event that a design element or signal net of package design 24 exceeds a manufacturing constraint or electrical specification. By way of example, design rules 52 may specify that a trace width is at least 20 μm, to ensure manufacturability. If a designer of system 10 implements trace 36B with 10 μm, for example, then CAD software 12 generates a DRC 54A, which may be graphically displayed on model 24A, as shown in FIG. 2. The user is thus made aware that a problem may exist with trace 36B.

Those skilled in the art appreciate that package design 24 often has more than the five levels illustrated in model 24A; however only five levels are shown in FIG. 2 for ease of illustration. For example, it is common that package design 24 include ground levels between each level with signal traces I(1), I(2) and I(3); however these ground levels are not shown to simplify illustration. Those skilled in the art also appreciate that package design 24 also typically has many more signal nets and other design elements than illustrated signal nets 30A and 30B. For example, package design 24 typically includes many other traces and vias (not shown) within package model 24A.

Signal nets 30A, 30B are also illustrated close together with substantially similar form, and in parallel (e.g., vias 35A, 35B are parallel) to illustrate that such a pair of signal nets may operate to transfer differential signals through package design 24. As those skilled in the art appreciate, differential signals provide benefits to electronic circuits, for example to provide enhanced signal discrimination, to reduce susceptibility to interference, and/or to accurately process bipolar signals.

FIG. 3 illustrates package model 24A in a side view. FIG. 3 further illustrates how package design 24 connects between a die 80 and a PCB 82. Connector 32A is for example a pad that connects with a solder ball 84A of die 80; connector 34A is for example a pad that connects with signal wires of PCB 82. Similarly, connector 32B is for example a pad that connects with a solder ball 84B of die 80; connector 34B is for example a pad that connects with signal wires of PCB 82. As shown, signal nets 30A, 30B illustrate an exemplary pair of conductors suitable for transferring a differential signal from die 80 to PCT 82.

The increased complexity of the modern die has correspondingly increased the complexity of the package design. An example of a complex die includes a Precision Architecture-Reduced Instruction Set Computer (PA-RISC) processor produced by Hewlett Packard Corporation, which has over one billion components. The package for the PA-RISC processor must maintain high signal integrity through its signal nets; this is especially true when the signal integrity involves differential signals. However the prior art CAD software does not simulate this signal integrity as required by the corresponding die. Accordingly, the package may be physically manufactured, at great expense, before the designer learns that the package is not suitable for operation with the die. Moreover, the DRCs generated by the prior art CAD software may assist in manufacturability; they do not, however, warn the designer of signal net incompatibilities between the die and the package. In one example, prior art CAD software 12 does not evaluate the spacing and parallelism between a pair of vias designed to carry differential signals of the package; if this spacing varies by more than a few microns, the differential signal can decouple and induce common mode noise or other undesirable artifacts.

### SUMMARY OF THE INVENTION

A method provides for evaluating via signal coupling in an electronic design. First, one or more via signal coupling rules are formulated (e.g., from designer input or from automated input through a die design). The electronic design is then processed to determine whether via signal coupling between via pairs of the electronic design violate the via signal coupling rules. If a violation occurs, an indicator (e.g., a DRC and/or a summary report) is generated to identify violated via signal coupling rules.

For example, in one aspect the step of processing includes the step of processing one signal net pair of the electronic design for violation of the via signal coupling rules. In this aspect, one or more via pairs of the signal net pair are evaluated for inter-via spacing relative to the via signal coupling rules. For example, these rules may specify that the inter-via spacing should be 200 μm, as a desired dimension between via pairs carrying differential signals. The rules may further specify a tolerance about the desired dimension, for example ±10% or ±20 μm. Accordingly, the step of processing, in one aspect, compares inter-via spacing for one or more via pairs in the electronic design to the desired dimension, plus or minus a tolerance, to determine violations of the via signal coupling rules.

In one aspect, the electronic design is a package design, and the step of formulating includes the step of formulating one or more group via signal coupling rules for a group of signal nets of the package design. The group of signal nets is then processed to determine whether inter-via spacings between differential signal net pairs of the group violate the group via signal coupling rules.

In another aspect, the step of generating includes the step of generating at least one DRC associated with one or more violations of the via signal coupling rules.

The via signal coupling rules can be defined in several ways. In one example, these rules define an inter-via spacing dimension to ensure signal coupling between via pairs in the electronic design. The step of processing determines whether the inter-via spacing of the via pairs differs from the inter-via spacing dimension.

In one aspect, the step of generating an indicator includes the step of graphically depicting a DRC on a graphical user interface illustrating the electronic design.

In another aspect, the step of processing includes the step of determining a spacing between each of the via pairs.

A software product is also provided. The software product has instructions, stored on computer-readable media, wherein the instructions, when executed by a computer, perform steps for evaluating via signal coupling in an electronic design, including: determining inter-via spacing between at least one via pair of the electronic design; comparing the spacing to one or more via signal coupling rules; and generating an indicator associated with the electronic design to identify violations of the via signal coupling rules.

In other aspects, the software product formulates one or more of the via signal coupling rules, through designer input or automated input from a die design, for example. The software product also determines whether one signal net in a group of signal nets has any via pairs that violate the via signal coupling rules. The software product may further generate a report summarizing violations of the via signal coupling rules. In one aspect, the software product compares spacing between via pairs in the electronic design and compares the spacing to a desired inter-via dimension set forth in the via signal coupling rules. The comparison may further consider tolerances about the desired dimension. In one aspect, the software product responds to inputs to scope the subsequent signal coupling evaluation of via pairs in the electronic design.

Various ones of the methods, systems and products may provide certain advantages. A system configured with the via signal coupling software can for example locate and evaluate inter-via spacings between via pairs in a package design, to compare the spacings relative to the via signal coupling rules. In one example, in order to maintain proper coupling for a pair of differential signal vias, the pair is evaluated for a desired dimension such as 200 μm. Such an evaluation may include a tolerance such as ±10% or ±20 μm, to maintain acceptable coupling. The via signal coupling software is thus operable to inform the designer that the via pair is not within tolerance, for example by generating a DRC and/or violation report.

### BRIEF DESCRIPTION OF THE DRAWINGS

FIG. 1 shows a prior art system and CAD software for designing a package;

FIG. 2 shows, in a perspective 3D view, one illustrative graphical model of the package design of FIG. 1;

FIG. 3 illustrates the package design of FIG. 1 in a side view;

FIG. 4 shows one system for evaluating signal coupling between vias in a package design;

FIG. 5 illustrates one package design processed by the system of FIG. 4;

FIG. 6 schematically illustrates traces and vias used in differential signaling, and the critical spacing between a pair of vias;

FIG. 7 is a flowchart illustrating one process for evaluating via signal coupling in an electronic design; and

FIG. 8A and FIG. 8B show a flowchart illustrating one method for processing a package design to evaluate signal coupling between vias.

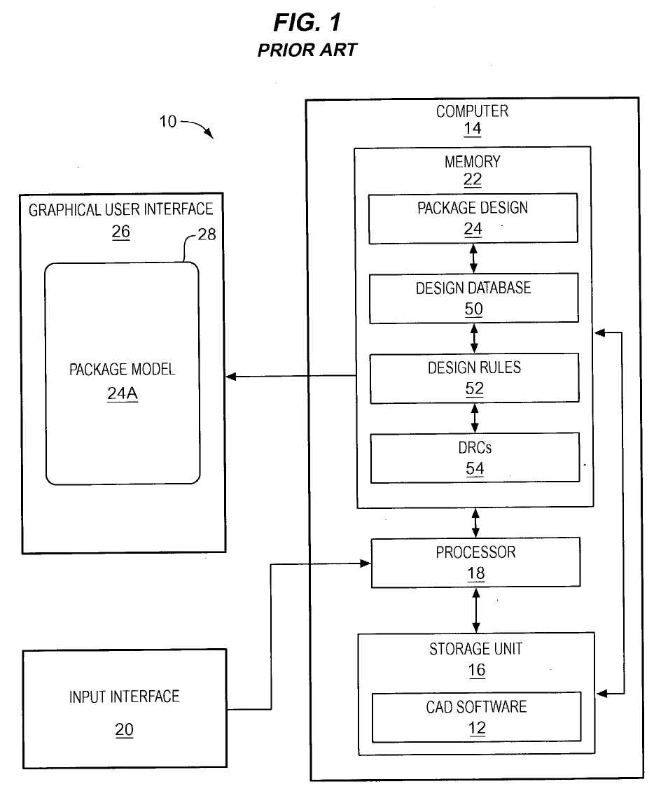

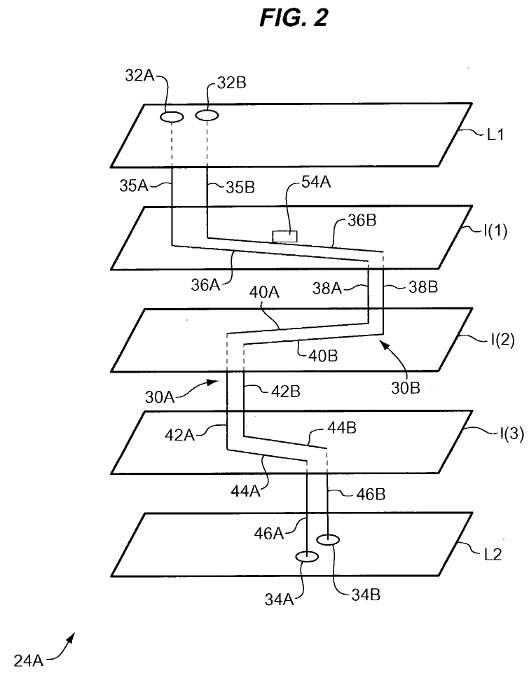

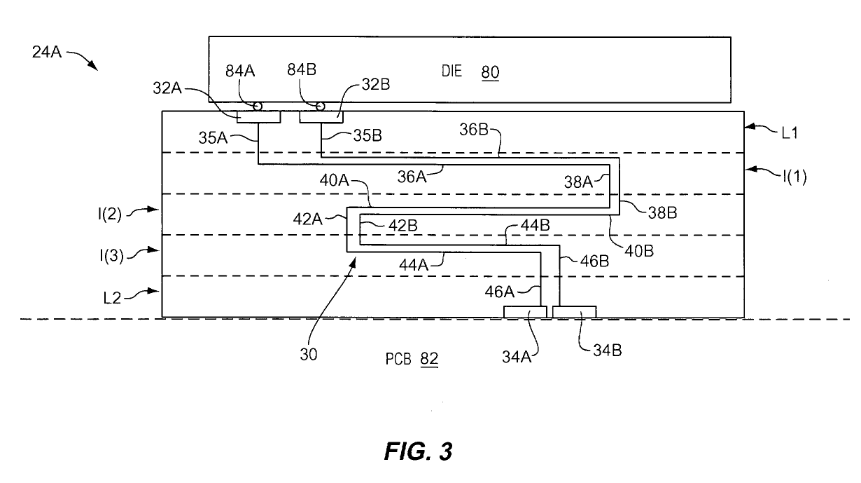

### DETAILED DESCRIPTION OF THE DRAWINGS

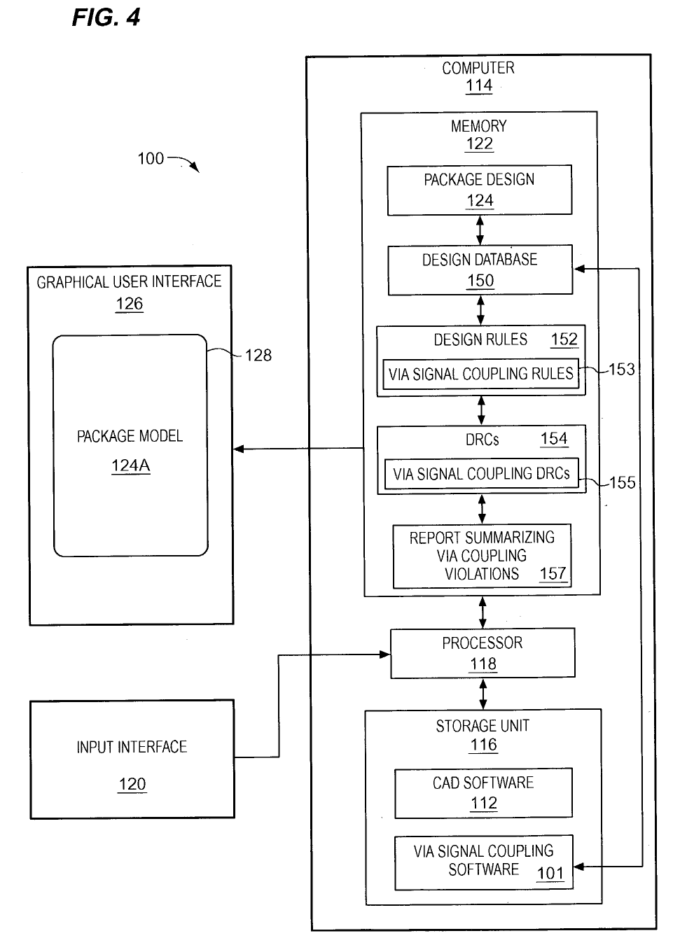

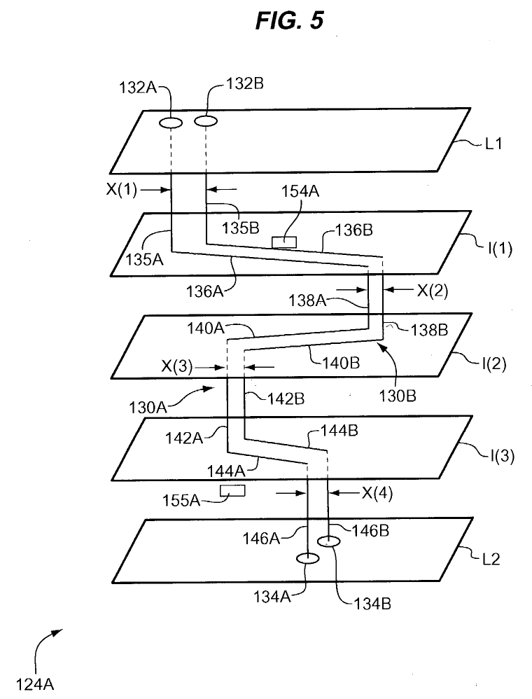

FIG. 4 shows one system 100 for designing and evaluating a package design utilizing CAD software 112 and via signal coupling software 101. CAD software 112 and via signal coupling software 101 are stored within a computer 114, initially within a storage unit 116. A processor 118 of computer 114 operates CAD software 112 and via signal coupling software 101 in response to user inputs at an input interface 120 (e.g., a computer keyboard and mouse). When initialized, CAD software 112 and via signal coupling software 101 may load into internal memory 122 of computer 114 as sets of instructions. A human designer at input interface 120 may then control CAD software 112 and via signal coupling software 101, through processor 118, to create a package design 124, also stored within memory 122. The designer can command processor 118 and CAD software 112 to graphically show package design 124 in one or more dimensions at a graphical user interface 126 (e.g., a computer monitor) of system 100. Illustratively, package design 124 is graphically depicted on a display 128 of graphical user interface 126 as a five-level package model 124A, shown and described in connection with FIG. 5. In FIG. 5, L1 of model 124A couples with a die, and L2 of model 124A couples with a PCB. Levels I(1), I(2) and (3) of model 124A represent intermediate levels of package design 124. Levels L1, I(1), I(2), I(3), L2 are shown as distinct elements and with not-to-scale orientations for ease of illustration.

An illustrative signal net 130 is shown in FIG. 5 from an input connector 132A to an output connector 134A of model 124A. Signal net 130A traverses design elements in the form of traces and vias between connectors 132A, 134A: via 135A from connector 132A of L1 to trace 136A of I(1); trace 136A within I(1) from via 135A to via 138A; via 138A from trace 136A of I(1) to trace 140A of I(2); trace 140A within I(2) from via 138A to via 142A; via 142A from trace 140A of I(2) to trace 144A of I(3); trace 144A within I(3) from via 142A to via 146A, which terminates at connector 134A of L2.

Another illustrative signal net 130B is shown in FIG. 5 from an input connector 132B to an output connector 134B of model 124A. Signal net 130B traverses design elements in the form of traces and vias between connectors 132B, 134B: via 135B from connector 132B of L1 to trace 136B of I(1); trace 136B within I(1) from via 135B to via 138B; via 138B from trace 136B of I(1) to trace 140B of I(2); trace 140B within I(2) from via 138B to via 142B; via 142B from trace 140B of I(2) to trace 144B of I(3); trace 144B within I(3) from via 142B to via 146B, which terminates at connector 134B of L2.

FIG. 5 also illustrates the spacing X between via pairs. X(1) is the spacing between vias 135A, 135B bridging differential signals from L1 to I(1). X(2) is the spacing between vias 138A, 138B bridging differential signals from I(1) to I(2). X(3) is the spacing between vias 142A, 142B bridging differential signals from I(2) to I(3). X(4 ) is the spacing between vias 146A, 146B bridging differential signals from I(3) to L2. As described in more detail below, system 100 is operable to evaluate any and all via pairs, and the spacing X therebetween, to ensure proper differential signal coupling in a package design.

With further regard to FIG. 4, CAD software 112 is also operable to generate a design database 150. In one example, design database 150 textually defines signal net 130A, including connectors 132A, 134A, traces 136A, 140A, 144A, and vias 135A, 138A, 142A, 146A. Design database also textually defines signal net 130B, including connectors 132B, 134B, traces 136B, 140B, 144B, and vias 135B, 138B, 142B, 146B.

Via signal coupling software 101 is operable to process design database 150 to determine and evaluate signal coupling between vias within package design 124. Design database 150 includes parameters (e.g., a netlist) to ensure that signal nets 130A, 130B have appropriate start and end points (i.e., that signal net 130A has start and end points 132A, 134A, respectively, and that signal net 130B has start and end points 132B, 134B, respectively). A designer can manipulate design database 150 to develop the desired package design 124. As a matter of design choice, via signal coupling software 101 may be combined with CAD software 112.

CAD software 112 processes design database 150 and utilizes design rules 152 to generate one or more Design Rule Checks (DRCs) 154 in the event that a design element or signal net of package design 124 exceeds a manufacturing constraint or electrical specification. One DRC 154A is illustratively shown in model 124A, FIG. 5, for example illustrating non-manufacturability of trace 136A. A DRC 154 may also be a textual indicator, for example a statement written to a report 157, described below. Illustratively, such a textual DRC 154 may for example state: DRC 154A=trace 136A violates physical constraint of 20 μm.

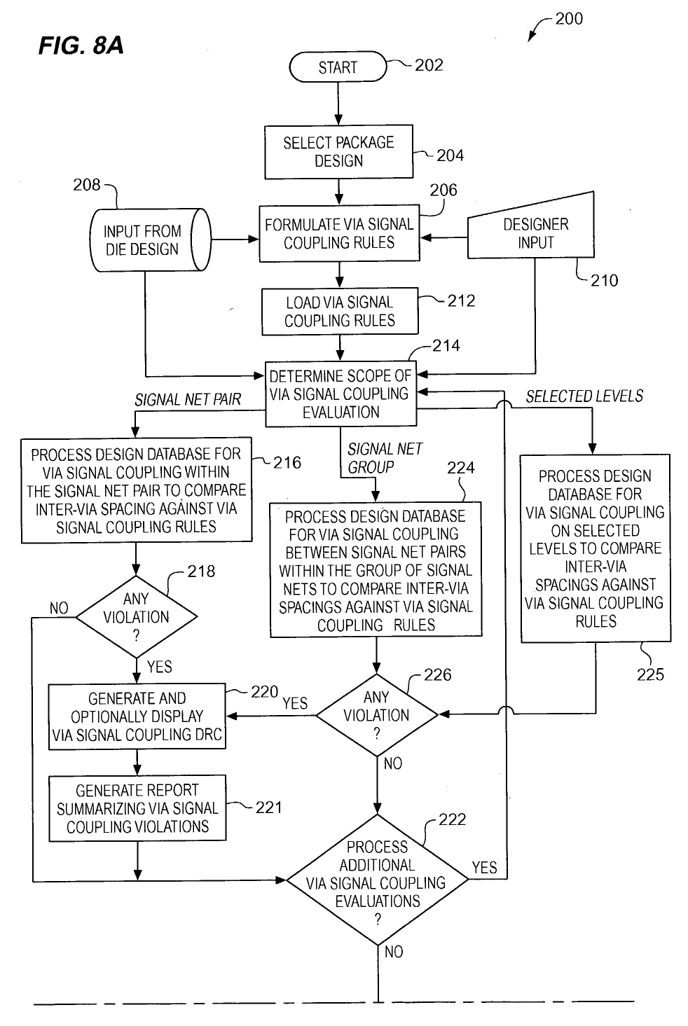

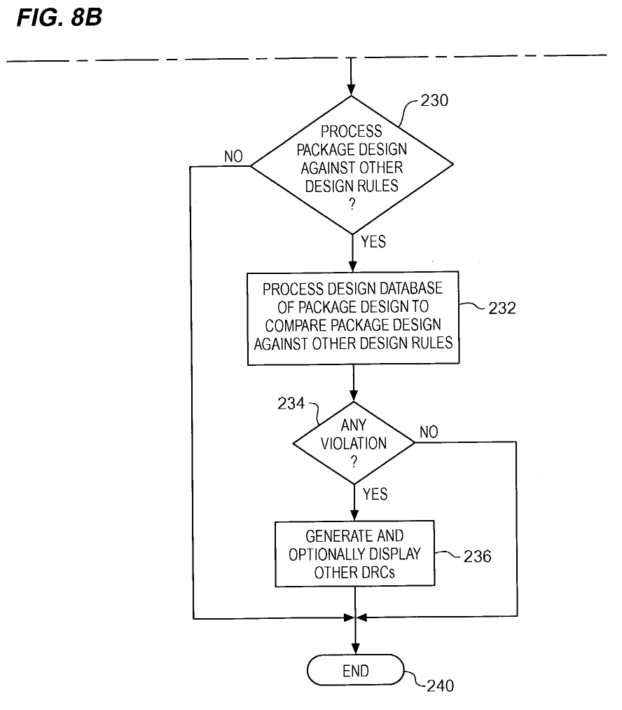

Via signal coupling software 101 processes design database 150 and utilizes via signal coupling rules 153 to generate one or more via signal coupling Design Rule Checks (DRCs) 155. One DRC 155A is illustratively shown in FIG. 5, indicating a violation of via signal coupling rules 153. DRC 155A for example illustrates that spacing X(4 ) between vias 146A, 146B is not allowed (or out of tolerance) according to via signal coupling rules 153. All violations of via signal coupling rules 153 may be summarized in a report 157 managed by via signal coupling software 101, as shown. FIG. 8A and FIG. 8B describe the operation of system 100 in its generation and utilization of via signal coupling rules 153 and DRCs 155. Illustratively, a representative via signal coupling rule may be stated textually as follows: for each pair of differential signal vias, the spacing between the vias =200 μm±10%. This illustrative rule ensures that each signal net pair used in differential coupling has an appropriate spacing between its vias to maintain coupling. A DRC 155 may also be a textual indicator, for example a statement written to report 157. Illustratively, such a textual DRC 155 may for example state: DRC 155=vias 146A, 146B of signal net pair 130A, 130B are separated by 240 μm and exceed the allowed via spacing of 200 μm±10%.

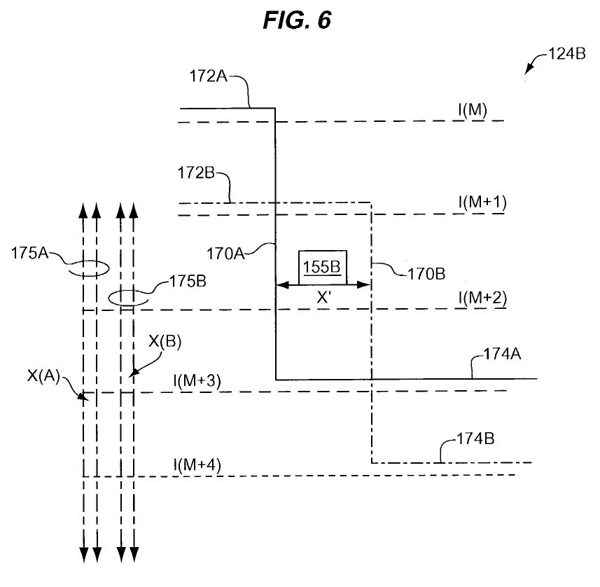

FIG. 6 schematically illustrates multiple inner levels I(M)-I(M+4) of one package design 124B. Two vias 170A, 170B provide differential signal coupling between level I(M+1) and level I(M+3). Via 170A couples with trace 172A of level I(M) and trace 174A of level I(M+3). Via 170B couples with trace 172B of level I(M+1) and trace 174B of level I(M+4). A critical dimension X′ exists as the spacing between via pair 170A, 170B, intended for use in carrying differential signals through the package. As described in more detail below, signal coupling software 101, FIG. 4, is operable to determine whether X′ meets designer guidelines set forth in via signal coupling rules 153. If X′ does not comply with the set of via signal coupling rules 153, a via signal coupling DRC 155B may be created to warn the designer of the offending via pair.

FIG. 6 also illustrates two additional via signal pairs 175A and 175B used in differential signal coupling within model 124A. Via signal pairs 175A, 175B also have critical dimensions, X(A) and X(B), respectively, that may be selectively monitored by via signal coupling software 101. Signal net pairs 175A, 175B and 175A/175B may for example be part of a signal net group to be processed and evaluated by system 100, FIG. 4.

In particular, as described in FIG. 8A an FIG. B, system 100 of FIG. 4 may generate any number of via signal coupling DRCs 155 when a via pair violates via signal coupling rules 153. Via signal coupling rules 153 may operate on one or a plurality of relationships between multiple signal nets 130, as described in FIG. 8A and FIG. 8B.

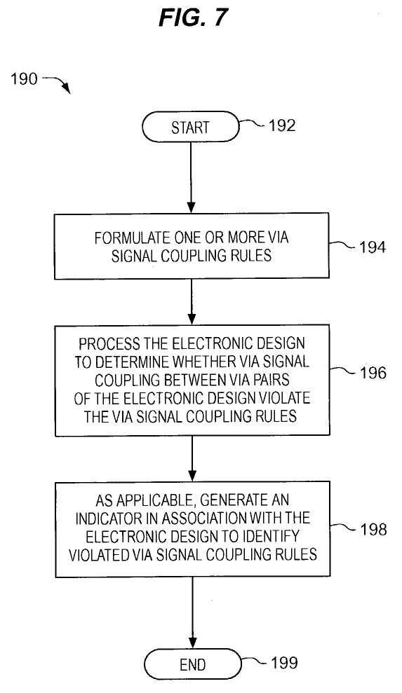

FIG. 7 is a flowchart illustrating one process 190 for evaluating via signal coupling in an electronic design. After start 192, one or more via signal coupling rules are formulated, in step 194. In step 196, the electronic design is processed to determine whether the via signal coupling between via pairs of the electronic design violate the via signal coupling rules. In step 198, an indicator (e.g., a via signal coupling DRC) is generated in association with the electronic design to identify violated via signal coupling rules, if any. Process 190 terminates at 199.

FIG. 8A and FIG. 8B show a flowchart illustrating one process 200 for generating and utilizing via signal coupling rules (e.g., rules 153) and via signal coupling DRCs (e.g., DRCs 155) with respect to a package design (e.g., design 124). System 100 of FIG. 4 for example utilizes process 200 to generate DRC 154A and DRC 155A in FIG. 5.

After start 202, a package design is selected in step 204; by way of example, step 204 may automatically select a current package design 124 being created by CAD software 112.

At step 206, via signal coupling rules are created. Process 200 shows two exemplary techniques for creating via signal coupling rules. In one example, via signal coupling rules are formulated 206 by processing input specifications of the die which couples with the package design, as indicated by direct data input 208. In another example, a designer manually formulates 206 via signal coupling rules, as indicated by designer input 210. The formulated via signal coupling rules are loaded to computer memory.(e.g., memory 122, FIG. 4) in step 212, so that the via signal coupling rules may operate with the package design selected in step 204. Via signal coupling software 101, FIG. 4, may perform or facilitate some or all of steps 206-212.

Step 214 determines the scope of subsequent via signal coupling evaluation. Illustratively, this determination 214 may derive from direct data input 208 associated with die specifications, or from designer inputs 210. The outputs of step 214 associate with the scope determined in step 214.

In one example, a designer selects a “signal net pair” of the package design to be processed for validation against the via signal coupling rules. Computer 114 of system 100 responds to the request to process design database 150 and evaluate dimensions between vias in the signal net pair, as indicated by step 216. For example, if signal net pair 130A, 130B of model 124A, FIG. 5, were selected, then all via spacings X(1)-X(4) are detected, evaluated and compared against via signal coupling rules 153.

In one example of step 216, the inter-via spacing between the differential signal net pair 130A, 130B is evaluated to determine whether X(1)-X(4) are 200 μm, a desired spacing dimension to ensure signal coupling. The via signal coupling rules in this example specify the desired 200 μm dimension. In another example, the via signal coupling rules additionally establish a tolerance about the desired inter-via spacing; such a tolerance is for example ±10% or ±20 μm.

Step 218 is a decision. If the signal net pair violates one or more of the via signal coupling rules, one or more via signal coupling DRCs 155 are generated (and optionally displayed with model 124A, for example, as DRC 155A), as indicated by step 220. Optionally, a designer may also publish a report summarizing violations of the via signal coupling rules, as in step 221. If no violation occurs, processing continues with step 222.

In another option, from step 214, a “signal net group” of a package design are processed for validation against the via signal coupling rules. Computer 114 of system 100 responds to the request and processes design database 150 to evaluate inter-via spacing dimensions between each differential signal net pair of the signal net group, in comparison against the via signal coupling rules, as indicated by step 224. Step 226 is a decision. For example, if a signal net group is selected that includes via signal pairs 175A, 175B and 170A/170B, FIG. 6, then computer 114 of system 100 responds to the request to process design database 150 and evaluate inter-via spacing dimensions between via pairs 175A, 175B, 170A/170B in the signal net group, as indicated by step 216. If one or more signal nets of the group violate one or more of the via signal coupling rules, one or more via signal coupling DRCs 155 are generated (and optionally displayed with model 124B, for example, as DRC 155B), as indicated by step 220. If no violation occurs, processing continues with step 222.

In other options, from step 214, “selected levels” of a package design are processed for validation against the via signal coupling rules. Computer 114 of system 100 responds to the request and processes design database 150 to evaluate inter-via spacing dimensions between each differential signal net pair of the selected level(s), in comparison against the via signal coupling rules, as indicated by step 225. Step 226 is a decision. For example, if the selected levels are I(1), I(2), (3) of package 124A, FIG. 5, then computer 114 of system 100 responds to the request to process design database 150 and evaluate inter-via spacing dimensions X(1)-X(4) between via pairs 135A/135, 138A/138B, 142A/142B, and 146A/146B, as indicated by step 225. If one or more via pairs of the selected level(s) violate one or more of the via signal coupling rules, one or more via signal coupling DRCs 155 are generated (and optionally displayed with model 124A, for example, as DRC 155A), as indicated by step 220. If no violation occurs, processing continues with step 222.

Step 222 is a decision. If additional via signal coupling evaluations (with differing scope) are designated, step 214 repeats; otherwise, process 200 continues with step 230. Step 230 is a decision. If the package design is to be evaluated against other design rules (e.g., rules 154, FIG. 4), step 232 processes the design database relative to the other design rules. Step 234 is a decision. If other DRCs 154 exist due to violation of the other design rules, process 200 continues with step 236; otherwise process 200 ends at step 240. In step 236, one or more other DRCs (e.g., DRC 154A, FIG. 4) may be generated and optionally displayed.

The following “pseudo” code illustrates one example for evaluating via coupling in a package design.

| | |
|---|---|
| ***Pseudo Code*** | |
| Variables: | |
| Die_Specification : | (Structure to contain specifics for die selected) |
| Die_Specification_File : | (Name of file containing die Specifications) |
| Package_Design_List : | (Structure to contain a list of all design elements of package design |
| | in the design database) |
| Design_Element_List : | (Structure to contain a list of design elements selected from the |
| | Package_Design_List) |
| Design_Name : | (Variable identifying the specific design to be validated) |
| Design_Rule_List : | (Structure to contain a list of design rules) |
| Design_Rule_Checks_List : | (Structure to contain a list of design rule violations) |

```
{Load Specification for the die used by the package into a list variable.}
Die_Specification := LoadDieSpecificationFromFile(Die_Specification_File);
{Load the package design from the package design database}
Package_Design_List := LoadPackageDesign(Design_Name);
{Generate die specific design rules from the die specification}
Design_Rule_List := GenerateDesignRules(Die_Specification);
{Add any design rules input by the designer}
Design_Rule_List := Design_Rule_List + Input_Designer_Rules( );
{Select all signal net pairs in the package design}
Design_Element_List := SelectDesignElementsForChecking(Package_Design_List,
Select_Signal_Net_Pairs);
{Empty the list for storing the DRCs detected}
Design_Rule_Check_List := EMPTY;
{The Design_Rule_Check function tests the selected design elements against all rules
in the Design_Rule_List, returning a DCR if the check fails. The DRC is added to the
Design_Rule_Checks_List for later processing.}
Design_Rule_Checks_List := Design_Rule_Check(Design_Element_List,
Design_Rule_List);
IF COUNT_ITEMS_IN_LIST(Design_Rule_Checks_List) > 0 THEN
BEGIN
    {Generate a DRC report for all detected DCRs}
    Generate_Design_Rule_Check_Report(Design_Rule_Checks_List);
    IF Design_Rule_Check_Display_Selected THEN
    BEGIN
        {If the DRCs are to be displayed on screen, the
        Generate_Design_Rule_Check_Display function sends the detected DCRs for
        output on the display}
        Generate_Design_Rule_Check_Display(Design_Rule_Checks_List);
    END IF;
END IF;
```

In this example, the Design_Element_List contains a list of all signal net pair design elements. The Design_Rule_Check function steps through all design rules in the Design_Rule_List, and tests each design element in each signal net pair in the Design Element List for coupling between vias. Only pseudo code for one via coupling rule is shown in the case statement for clarity. The pseudo code for the via coupling rule uses a function that calculates the coupling between two vias, and allows comparison to maximum coupling levels defined in the via coupling rule.

FUNCTION Design_Rule_Check(Design_Element_List,Design_Rule_List) : DRC_List;

| | |
|---|---|
| VARIABLES | |
| Design_Rule_Index : | (Index variable used to step through Design_Rule_List) |
| Design_Element_Index : | (Index variable used to step through Design Element List) |
| DRC_List : | (List to build the Returned DRCs) |
| First_Net_List : | (List of design elements in first netlist of pair) |
| Second_Net_List : | (List of design elements in second netlist of pair) |
| First_Index : | (Index variable into First_Net_List) |
| Second_Index : | (Index variable into Second_Net_List) |
| BEGIN | |

```
DRC_List := EMPTY; {Clear the return DCR list}
{Step through the design rules in the Design Rule List and check each design
element in the Design Element List to which the rule applies. Accumulate DRCs
in the DRC_List to be returned at the end of the function.}
FOR Design_Rule_Index := 1 to COUNT_ITEMS_IN_LIST(Design_Rule_List) DO
BEGIN
    CASE Design_Rule_List[Design_Rule_Index].Type OF
    ...
    Via_Coupling_Rule:
    BEGIN
        {Separate the pair of Netlists for comparison}
        First_Net_List := Select_First_Netlist(Design_Element_List);
        Second_Net_List := Select_Second_Netlist(Design_Element_List);
        {Step through the first netlist a compare the coupling of elements in the
        second netlist that are on the same level}
        FOR First_Index := 1 to COUNT_ITEMS_IN_LIST(First_Net_List) DO
        BEGIN
            FOR Second_Index := 1 to COUNT_ITEMS_IN_LIST(Second_Net_List) DO
            BEGIN
                IF First_Net_List [First_Index].Level = Second_Net_List [Second_Index].Level
                    THEN
                BEGIN
                    IF ComputeCoupling(FirstNetList[First_Index],
                                Second_Net_List[Second_Index]) <
                        Design_Rule_List[Design_Rule_Index].Minimum THEN
                        BEGIN
                            {The Rule failed, so add the DCR to the DCR list to be
                            returned on completion of the function}
                            DRC_List := DRC_List +
                                DRC(Design_Rule_List[Design_Rule_Index].Type);
                        END IF;
                    END IF;
                END FOR;
            END FOR;
        END Via_Coupling_Rule;
        ...
    END CASE;
END FOR;
RETURN DRC_List; {Return the results for the Design Rule Check function}
```

END FUNCTION;
***End Pseudo Code***

Changes may be made in the above methods and systems without departing from the scope hereof. It should thus be noted that that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between

What is claimed is:

1. A method for evaluating via signal coupling in an electronic design, comprising the steps of:
formulating one or more via signal coupling rules;
processing the electronic design to determine whether the via signal coupling between via pairs of the electronic design violate the via signal coupling rules; and
generating an indicator associated with the electronic design to identify violated via signal coupling rules.

2. A method of claim 1, the step of processing comprising the step of processing one signal net pair of the electronic design for violation of the via signal coupling rules.

3. A method of claim 1, the electronic design comprising a package design, the step of formulating comprising the step of formulating one or more group via signal coupling rules for a group of signal nets of the package design, wherein the step of processing comprises the step of processing the group of signal nets to determine whether inter-via spacings between differential signal net pairs of the group violate the group via signal coupling rules.

4. A method of claim 3, the step of generating comprising the step of generating at least one DRC for one or more violations of the group via signal coupling rules.

5. A method of claim 1, wherein the step of formulating one or more via signal coupling rules comprises defining an inter-via spacing dimension to ensure signal coupling between the via pairs, the step of processing comprising the step of determining whether the inter-via spacing of the via pairs differs from the inter-via spacing dimension.

6. A method of claim 5, the inter-via dimension comprising approximately 200 microns.

7. A method of claim 5, step of formulating comprising the step of defining a tolerance about the dimension.

8. A method of claim 7, the tolerance comprising one of (a) 10% deviation from the dimension and (2) 20 microns deviation from the dimension.

9. A method of claim 7, the step of processing comprising the step of determining whether the inter-via spacing of the via pairs differs from the inter-via spacing dimension, plus or minus the tolerance.

10. A method of claim 1, the step of generating an indicator comprising the step of graphically depicting a DRC on a graphical user interface illustrating the electronic design.

11. A method of claim 1, the step of processing comprising the step of determining a spacing between each of the via pairs.

12. A method of claim 1, the electronic design comprising a package design, the via signal coupling rules defining via signal coupling for a group of signal nets of the package design.

13. A method of claim 1, the step of generating an indicator comprising generating a report summarizing violations of the via signal coupling rules.

14. A software product comprising instructions, stored on computer-readable media, wherein the instructions, when executed by a computer, perform steps for evaluating via signal coupling in an electronic design, comprising:
determining inter-via spacing between at least one via pair of the electronic design;
comparing the spacing to one or more via signal coupling rules; and
generating an indicator associated with the electronic design to identify violations of the via signal coupling rules.

15. The software product of claim 14, further comprising formulating one or more of the via signal coupling rules.

16. The software product of claim 14, further comprising determining whether one signal net in a group of signal nets has any via pairs that violate the via signal coupling rules.

17. The software product of claim 14, further comprising generating a report summarizing violations of the via signal coupling rules.

18. The software product of claim 14, the step of comparing comprising the step of comparing the spacing to a desired inter-via dimension set forth in the via signal coupling rules.

19. The software product of claim 18, the step of comparing comprising the step of comparing the spacing to the desired inter-via dimension with a tolerance defined in the via signal coupling rules.

20. The software product of claim 14, further comprising responding to designer inputs to scope the step of determining inter-via spacing of the at least one via pair.

21. A system for evaluating via signal coupling in an electronic design, comprising:
means for formulating one or more via signal coupling rules;
means for processing the electronic design to determine whether the via signal coupling between via pairs of the electronic design violate the via signal coupling rules; an
means for generating an indicator associated with the electronic design to identify violated via signal coupling rules.
